(19) United States
(12) Patent Application Publication
(10) Pub. No.: US 2021/0233405 A1
(43) Pub. Date: Jul. 29, 2021

(54) PARKING LOT FREE PARKING SPACE PREDICTING METHOD, APPARATUS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Weijia ZHANG, Beijing (CN); Hao LIU, Beijing (CN); Hui XIONG, Beijing (CN)

(73) Assignee: BEIJING BAIDU NETCOM SCIENCE AND TECHNOLOGY CO., LTD., Beijing (CN)

(21) Appl. No.: 17/024,421

(22) Filed: Sep. 17, 2020

(30) Foreign Application Priority Data
Jan. 23, 2020 (CN) 202010076198.7

(51) Int. Cl. G08G 1/14; G06N 3/04; G06N 3/08

(52) U.S. Cl. CPC G08G 1/148; G06N 3/08; G06N 3/0445; G06N 3/0454

(57) ABSTRACT

The present disclosure provides a parking lot free parking space predicting method and apparatus etc., and relates to the field of artificial intelligence. The method comprises: building a parking lot association graph and an information propagation graph for parking lots in a region to be processed, each junction in the graphs representing a parking lot, and connecting parking lots meeting a predetermined condition through edges; as for any parking lot i without a real-time sensor, determining local space correlation information of parking lot i according to environment context features of the parking lot i and neighboring parking lots which are in the parking lot association graph and connected to the parking lot i through edges; determining free parking space estimation information of the parking lot i according to free parking space information of neighboring parking lots with real-time sensors in the information propagation graph; determining time correlation information of the parking lot i according to the determined two kinds of information, and predicting future free parking space information of the parking lot i according to the information. The solution of the present disclosure may be applied to improve the accuracy of the prediction result.

The present application claims the priority of Chinese Patent Application No. 202010076198.7, filed on Jan. 23, 2020, with the title of “Parking lot free parking space predicting method, apparatus, electronic device and storage medium”. The disclosure of the above application is incorporated herein by reference in its entirety.

### FIELD OF THE DISCLOSURE

The present disclosure relates to computer application technologies, and particularly to a parking lot free parking space predicting method, apparatus, electronic device and storage medium in the field of artificial intelligence.

### BACKGROUND OF THE DISCLOSURE

When drivers need to park vehicles, they usually want to know which nearby parking lots can provide free parking spaces in near future, and correspondingly, if free parking space information of parking lots can be predicted, the drivers' parking efficiency can be improved effectively.

At present, annotation data may be generated based on a user's feedback, thereby predicting a degree of difficulty in parking vehicles in a certain region.

However, the annotation data obtained in this manner might be inaccurate, for example, the user himself does not have precise metrics of the degree of parking difficulty and provides a coarse evaluation only by virtue of his own feeling.

Furthermore, some misoperations of the user might occur and affect the feedback accuracy. The prediction results are very inaccurate on account of these problems.

### SUMMARY OF THE DISCLOSURE

In view of the above, the present application provides a parking lot free parking space predicting method, apparatus, electronic device and storage medium.

A parking lot free parking space predicting method, comprising:

building a parking lot association graph for parking lots in a region to be processed, each junction therein representing a parking lot, and connecting any two parking lots meeting a first predetermined condition through edges;

building an information propagation graph for parking lots in the region to be processed, each junction therein representing a parking lot, and connecting a parking lot without a real-time sensor with a parking lot having a real-time sensor and meeting a second predetermined condition through edges;

processing as follows for any parking lot i without a real-time sensor:

determining local space correlation information of parking lot i at a current time according to environment context features of the parking lot i and neighboring parking lots which are in the parking lot association graph and connected to the parking lot i through edges;

determining free parking space estimation information of the parking lot i at the current time according to free parking space information of neighboring parking lots connected to the parking lot i through edges in the information propagation graph;

determining time correlation information of the parking lot i at the current time according to the free parking space estimation information and the local space correlation information, and predicting free parking space information of the parking lot i at at least one future time step according to the time correlation information of the parking lot i at the current time.

According to a preferred embodiment of the present disclosure, the connecting any two parking lots meeting a predetermined condition through edges comprises: connecting any two parking lots with a distance less than or equal to a predetermined threshold through edges;

the connecting a parking lot without a real-time sensor with a parking lot having a real-time sensor and meeting a second predetermined condition through edges comprises: as for any parking lot i without a real-time sensor, sorting the parking lots with real-time sensors respectively in an ascending order of distance from the parking lot i, and determining a first distance between a parking lot ranking at L after the sorting and the parking lot i, L being a positive integer, connecting parking lots ranking before L with the parking lot i through edges if the first distance is greater than a threshold, otherwise connecting parking lots of which a distance from the parking lot i is less than or equal to the threshold and which have real-time sensors with the parking lot i through edges.

According to a preferred embodiment of the present disclosure, the determining local space correlation information of parking lot i at a current time comprises: determining local space correlation information of parking lot i at a current time based on a graph attention neutral network model;

the determining time correlation information of the parking lot i at the current time, and the predicting free parking space information of the parking lot i at at least one future time step according to the time correlation information of the parking lot i at the current time comprises: determining time correlation information of the parking lot i at the current time based on a gated recurrent neural network model, and predicting the free parking space information of the parking lot i at at least one future time step according to the time correlation information of the parking lot i at the current time.

According to a preferred embodiment of the present disclosure, the determining local space correlation information of parking lot i at a current time based on a graph attention neutral network model comprises:

as for neighboring parking lots of parking lot i in the parking lot association graph, determining weights of edges between the neighboring parking lots and the parking lot i at the current time according to the environment context features of the neighboring parking lots and parking lot i at the current time, respectively;

aggregating the environment context features of the neighboring parking lots according to the weights of edges between the neighboring parking lots and the parking lot i to obtain a representation vector of the parking lot i, and regarding the representation vector as the local space correlation information of the parking lot i at the current time.

According to a preferred embodiment of the present disclosure, a weight αᵢⱼ of the edge between any neighboring parking lot j and parking lot i is represented by

$${α}_{ij} = \frac{exp ( {c}_{ij} )}{{Σ}_{k ∈ {N}_{i}} exp ( {c}_{ik} )} ,$$

where cᵢⱼ=Attention(Wₐxᵢ,Wₐxⱼ); Attention represents a graph attention mechanism; Nᵢ represents the number of neighboring parking lots of the parking lot i in the parking lot association graph; xᵢ represents the environment context feature of the parking lot i at the current time; xⱼ represents the environment context feature of neighboring parking lot j at the current time; Wₐ represents a model parameter obtained by pre-training.

According to a preferred embodiment of the present disclosure, the representation vector xᵢ′=σ(Σ_{j∈N}_{ᵢ}αᵢⱼWₐxⱼ);

where Nᵢ represents number of neighboring parking lots of the parking lot i in the parking lot association graph; xⱼ represents the environment context feature of any neighboring parking lot j among Nᵢ neighboring parking lots at the current time; αᵢⱼ represents a weight of the edge between the neighboring parking lot j and parking lot i at the current time; Wₐ represents a model parameter obtained by pre-training; σ represents an activation function.

According to a preferred embodiment of the present disclosure, the determining free parking space estimation information of the parking lot i at the current time comprises:

as for the neighboring parking lots of the parking lot i in the information propagation graph, determining weights of edges between the neighboring parking lots and the parking lot i at the current time according to environment context features of the neighboring parking lots and the parking lot i at the current time, respectively;

determining free parking space estimation information of the parking lot i in a space dimension at the current time according to the weights of edges between the neighboring parking lots and the parking lot i and the free parking space information of the neighboring parking lots at the current time.

According to a preferred embodiment of the present disclosure, the free parking space estimation information xᵢ^{sp} of the parking lot i in the space dimension at the current time is represented by xᵢ^{sp}=Σ_{j∈Q}_{ᵢ}α′ᵢⱼyⱼ;

where Qᵢ represents the number of neighboring parking lots of the parking lot i in the information propagation graph; yⱼ represents the free parking space information of any neighboring parking lot j in Qᵢ neighboring parking lots at the current time; α′ᵢⱼ represents a weight of the edge between the neighboring parking lot j and parking lot i at the current time.

According to a preferred embodiment of the present disclosure, the method further comprises:

as for the parking lot i, determining free parking space estimation information of the parking lot i in a time dimension at the current time according to output of the gated recurrent neural network model at a previous time;

fusing the free parking space estimation information in the time dimension with the free parking space estimation information in the space dimension to obtain finally-needed free parking space estimation information of the parking lot i at the current time.

According to a preferred embodiment of the present disclosure, the free parking space estimation information xᵢ^{tp} of the parking lot i in the time dimension at the current time is represented by xᵢ^{tp}=Softmax(Wₜₚhᵢ^{t-1});

where Wₜₚ is a model parameter obtained by pre-training; hᵢ^{t-1} represents output of the gated recurrent neural network model at the previous time.

According to a preferred embodiment of the present disclosure, the fused free parking space estimation information xᵢ^{p} of the parking lot i is represented by

$${x}_{i}^{p} = \frac{exp ( - H ( {x}_{i}^{sp} ) ) {x}_{i}^{sp} + exp ( - H ( {x}_{i}^{tp} ) ) {x}_{i}^{tp}}{{z}_{i}} ;$$

where Zᵢ=exp(−H(xᵢ^{sp}))+exp(−H(xᵢ^{tp})) and is a normalization factor; xᵢ^{sp} represents the free parking space estimation information of the parking lot i in the space dimension at the current time; xᵢ^{tp} represents the free parking space estimation information of the parking lot i in the time dimension at the current time; H represents a predetermined function.

According to a preferred embodiment of the present disclosure, before determining time correlation information of the parking lot i at the current time based on a gated recurrent neural network model, the method further comprises:

concatenating the free parking space estimation information of the parking lot i at the current time with the local space correlation information;

the determining time correlation information of the parking lot i at the current time based on a gated recurrent neural network model comprises: determining the time correlation information of parking lot i at the current time according to a concatenation result and output of the gated recurrent neural network model at a previous time.

According to a preferred embodiment of the present disclosure, the time correlation information hᵢ^{t} of the parking lot i at the current time is represented by

hᵢ^{t}=(1−zᵢ^{t})·hᵢ^{t-1}+zᵢ^{t}·\tilde{h}ᵢ^{t};

where zᵢ^{t}=σ(W_{z}[hᵢ^{t-1},xᵢ″]+b_{z});

\tilde{h}ᵢ^{t}=tan h(W_{\tilde{h}}[rᵢ^{t}·hᵢ^{t-1},xᵢ″]+b_{\tilde{h}});

rᵢ^{t}=σ(Wᵣ[hᵢ^{t-1},xᵢ″]+bᵣ);

W_{z}, W_{\tilde{h}}, Wᵣ, b_{z}, b_{\tilde{h}} and bᵣ all are model parameters obtained by pre-training; σ represents an activation function; xᵢ″ represents the concatenation result; hᵢ^{t-1} represents the output of the gated recurrent neural network model at the previous time.

According to a preferred embodiment of the present disclosure, the predicting free parking space information of the parking lot i at at least one future time step according to the time correlation information of the parking lot i at the current time comprises:

predicting the free parking space information of the parking lot i at future r time steps in the following manner: (ŷᵢ^{t+1}, . . . , ŷᵢ^{t+τ})=σ(Wₒhᵢ^{t});

where τ is a positive integer greater than one; hᵢ^{t} represents the time correlation information of the parking lot i at the current time; Wₒ represents a model parameter obtained by pre-training, σ represents an activation function; ŷᵢ^{t+1} represents the predicted free parking space information of the parking lot i at a first future time step; ŷᵢ^{t+τ} represents the predicted free parking space information of the parking lot i at τ^{th} future time step.

According to a preferred embodiment of the present disclosure, the method further comprises:

when performing model training, selecting Nₗ parking lots with real-time sensors as sample parking lots, building annotation data based on historical free parking space information of the sample parking lots, performing training optimization based on the annotation data, and minimizing a combined objective function O;

$$where O = {O}_{1} + \frac{1}{2} ( {O}_{2} + {O}_{3} ) ;$$

$${O}_{1} = \frac{1}{τ {N}_{l}} {\sum }_{i = 1}^{{N}_{l}} {\sum }_{j = 1}^{τ} {( {\hat{y}}_{i}^{t + j} - {y}_{i}^{t + j} )}^{2} ;$$

$${O}_{2} = - \frac{1}{{N}_{l}} {\sum }_{i = 1}^{{N}_{l}} {y}_{i}^{t} log {x}_{i}^{sp} ;$$

$${O}_{3} = - \frac{1}{{N}_{l}} {\sum }_{i = 1}^{{N}_{l}} {y}_{i}^{t} log {x}_{i}^{tp} ;$$

where Nₗ is a positive integer greater than 1; yᵢ^{t+j} represents real free parking space information of any sample parking lot i at a corresponding time step; yᵢ^{t} represents real free parking space information of the sample parking lot i at a time t after predetermined processing; xᵢ^{sp} represents free parking space estimation information of the sample parking lot i in a space dimension at a time t; xᵢ^{tp} represents free parking space estimation information of the sample parking lot i in a time dimension at a time t.

A parking lot free parking space predicting apparatus, comprising a building unit and a predicting unit;

the building unit is configured to build a parking lot association graph for parking lots in a region to be processed, each junction therein representing a parking lot, and connect any two parking lots meeting a first predetermined condition through edges; build an information propagation graph for parking lots in the region to be processed, each junction therein representing a parking lot, and connect a parking lot without a real-time sensor with a parking lot having a real-time sensor and meeting a second predetermined condition through edges;

the predicting unit is configured to process as follows for any parking lot i without a real-time sensor: determine local space correlation information of parking lot i at a current time according to environment context features of the parking lot i and neighboring parking lots which are in the parking lot association graph and connected to the parking lot i through edges; determine free parking space estimation information of the parking lot i at the current time according to free parking space information of neighboring parking lots connected to the parking lot i through edges in the information propagation graph; determine time correlation information of the parking lot i at the current time according to the free parking space estimation information and the local space correlation information, and predict free parking space information of the parking lot i at at least one future time step according to the time correlation information of the parking lot i at the current time.

According to a preferred embodiment of the present disclosure, as for the parking lot association graph, the building unit connects any two parking lots with a distance less than or equal to a predetermined threshold through edges;

as for the information propagation graph, the building unit, as for any parking lot i without a real-time sensor, sorts the parking lots with real-time sensors respectively in an ascending order of distance from the parking lot i, and determines a first distance between a parking lot ranking at L after the sorting and the parking lot i, L being a positive integer, connects parking lots ranking before L with the parking lot i through edges if the first distance is greater than a threshold, otherwise connects parking lots of which a distance from the parking lot i is less than or equal to the threshold and which have real-time sensors with the parking lot i through edges.

According to a preferred embodiment of the present disclosure, the predicting unit determines local space correlation information of parking lot i at a current time based on a graph attention neutral network model;

the predicting unit determines time correlation information of the parking lot i at the current time based on a gated recurrent neural network model, and predicts the free parking space information of the parking lot i at at least one future time step according to the time correlation information of the parking lot i at the current time.

According to a preferred embodiment of the present disclosure, as for neighboring parking lots of parking lot i in the parking lot association graph, the predicting unit determines weights of edges between the neighboring parking lots and the parking lot i at the current time according to the environment context features of the neighboring parking lots and parking lot i at the current time, respectively, aggregates the environment context features of the neighboring parking lots according to the weights of edges between the neighboring parking lots and the parking lot i to obtain a representation vector of the parking lot i, and regards the representation vector as the local space correlation information of the parking lot i at the current time.

According to a preferred embodiment of the present disclosure, a weight αᵢⱼ of the edge between any neighboring parking lot j and parking lot i is represented by

$${α}_{ij} = \frac{exp ( {c}_{ij} )}{{\sum }_{k ∈ {N}_{i}} exp ( {c}_{ik} )} ;$$

where cᵢⱼ=Attention(Wₐxᵢ,Wₐxⱼ); Attention represents a graph attention mechanism; Nᵢ represents the number of neighboring parking lots of the parking lot i in the parking lot association graph; xᵢ represents the environment context feature of the parking lot i at the current time; xⱼ represents the environment context feature of neighboring parking lot j at the current time; Wₐ represents a model parameter obtained by pre-training.

According to a preferred embodiment of the present disclosure, the representation vector xᵢ′=σ(Σ_{j∈N}_{ᵢ}αᵢⱼWₐxⱼ);

where Nᵢ represents number of neighboring parking lots of the parking lot i in the parking lot association graph; xⱼ represents the environment context feature of any neighboring parking lot j among Nᵢ neighboring parking lots at the current time; αᵢⱼ represents a weight of the edge between the neighboring parking lot j and parking lot i at the current time; Wₐ represents a model parameter obtained by pre-training; σ represents an activation function.

According to a preferred embodiment of the present disclosure, as for the neighboring parking lots of the parking lot i in the information propagation graph, the predicting unit determines weights of edges between the neighboring parking lots and the parking lot i at the current time according to environment context features of the neighboring parking lots and the parking lot i at the current time, respectively, and determines free parking space estimation information of the parking lot i in a space dimension at the current time according to the weights of edges between the neighboring parking lots and the parking lot i and the free parking space information of the neighboring parking lots at the current time.

According to a preferred embodiment of the present disclosure, the free parking space estimation information xᵢ^{sp} of the parking lot i in the space dimension at the current time is represented by xᵢ^{sp}=Σ_{j∈Q}_{ᵢ}α′ᵢⱼyⱼ;

where Qᵢ represents the number of neighboring parking lots of the parking lot i in the information propagation graph; yⱼ represents the free parking space information of any neighboring parking lot j in Qᵢ neighboring parking lots at the current time; α′ᵢⱼ represents a weight of the edge between the neighboring parking lot j and parking lot i at the current time.

According to a preferred embodiment of the present disclosure, as for the parking lot i, the predicting unit is further configured to determine free parking space estimation information of the parking lot i in a time dimension at the current time according to output of the gated recurrent neural network model at a previous time, and fuse the free parking space estimation information in the time dimension with the free parking space estimation information in the space dimension to obtain finally-needed free parking space estimation information of the parking lot i at the current time.

According to a preferred embodiment of the present disclosure, the free parking space estimation information xᵢ^{tp} of the parking lot i in the time dimension at the current time is represented by xᵢ^{tp}=Softmax(Wₜₚhᵢ^{t-1});

where Wₜₚ is a model parameter obtained by pre-training; hᵢ^{t-1} represents output of the gated recurrent neural network model at the previous time.

According to a preferred embodiment of the present disclosure, the fused free parking space estimation information xᵢ^{p} of the parking lot i is represented by

$${x}_{i}^{p} = \frac{exp ( - H ( {x}_{i}^{sp} ) ) {x}_{i}^{sp} + exp ( - H ( {x}_{i}^{tp} ) ) {x}_{i}^{tp}}{{Z}_{i}} ;$$

where Zᵢ=exp(−H(xᵢ^{sp}))+exp(−H(xᵢ^{tp})) and is a normalization factor; xᵢ^{sp} represents the free parking space estimation information of the parking lot i in the space dimension at the current time; xᵢ^{tp} represents the free parking space estimation information of the parking lot i in the time dimension at the current time; H represents a predetermined function.

According to a preferred embodiment of the present disclosure, the predicting unit is further configured to concatenate the free parking space estimation information of the parking lot i at the current time with the local space correlation information, and determine the time correlation information of parking lot i at the current time according to a concatenation result and output of the gated recurrent neural network model at a previous time.

According to a preferred embodiment of the present disclosure, the time correlation information hᵢ^{t} of the parking lot i at the current time is represented by

hᵢ^{t}=(1−zᵢ^{t})·hᵢ^{t-1}+zᵢ^{t}·\tilde{h}ᵢ^{t};

where zᵢ^{t}=σ(W_{z}[hᵢ^{t-1},xᵢ″]+b_{z});

\tilde{h}ᵢ^{t}=tan h(W_{\tilde{h}}[rᵢ^{t}·hᵢ^{t-1},xᵢ″]+b_{\tilde{h}});

rᵢ^{t}=σ(Wᵣ[hᵢ^{t-1},xᵢ″]+bᵣ);

W_{z}, W_{\tilde{h}}, Wᵣ, b_{z}, b_{\tilde{h}} and bᵣ all are model parameters obtained by pre-training; σ represents an activation function; xᵢ″ represents the concatenation result; hᵢ^{t-1} represents the output of the gated recurrent neural network model at the previous time.

According to a preferred embodiment of the present disclosure, the predicting unit predicts the free parking space information of the parking lot i at future τ time steps in the following manner: (ŷᵢ^{t+1}, . . . , yᵢ^{t+τ})=σ(Wₒhᵢ^{t});

where τ is a positive integer greater than one; hᵢ^{t} represents the time correlation information of the parking lot i at the current time; Wₒ represents a model parameter obtained by pre-training, a represents an activation function; ŷᵢ^{t+1} represents the predicted free parking space information of the parking lot i at a first future time step; ŷᵢ^{t+τ} represents the predicted free parking space information of the parking lot i at τ^{th} future time step.

According to a preferred embodiment of the present disclosure, the apparatus further comprises: a pre-processing unit configured to perform model training, where Nₗ parking lots with real-time sensors are selected as sample parking lots, annotation data are built based on historical free parking space information of the sample parking lots, training optimization is performed based on the annotation data, and a combined objective function O is be minimized;

$$where O = {O}_{1} + \frac{1}{2} ( {O}_{2} + {O}_{3} ) ;$$

$${O}_{1} = \frac{1}{τ {N}_{l}} {\sum }_{i = 1}^{{N}_{l}} {\sum }_{j = 1}^{τ} {( {\hat{y}}_{i}^{t + j} - {y}_{i}^{t + j} )}^{2} ;$$

$${O}_{2} = - \frac{1}{{N}_{l}} {\sum }_{i = 1}^{{N}_{l}} {y}_{i}^{t} log {x}_{i}^{sp} ;$$

$${O}_{3} = - \frac{1}{{N}_{l}} {\sum }_{i = 1}^{{N}_{l}} {y}_{i}^{t} log {x}_{i}^{tp} ;$$

where Nₗ is a positive integer greater than 1; yᵢ^{t+j} represents real free parking space information of any sample parking lot i at a corresponding time step; yᵢ^{t} represents real free parking space information of the sample parking lot i at a time t after predetermined processing; xᵢ^{sp} represents free parking space estimation information of the sample parking lot i in a space dimension at a time t; xᵢ^{tp} represents free parking space estimation information of the sample parking lot i in a time dimension at a time t.

An electronic device, comprising:

at least one processor; and

a memory communicatively connected with the at least one processor; wherein,

the memory stores instructions executable by the at least one processor, and the instructions are executed by the at least one processor to enable the at least one processor to perform the method stated above.

A computer-readable storage medium storing computer instructions therein, wherein the computer instructions are used to cause the computer to perform the method stated above.

Embodiments of the present disclosure have the following advantages or advantageous effects: the local space correlation information and the time correlation information of the parking lot may be determined in conjunction with the environment context features of the parking lot, the free parking space information of the parking lots without real-time sensors may be estimated/complemented by using the free parking space information of the parking lots with real-time sensors, and future free parking space information of the parking lot may be predicted based on these information, thereby improving the accuracy of the prediction result; in addition, the free parking space information of the parking lot may be complemented in a space dimension and a time dimension, thereby enhancing the accuracy of the processing result and further enhancing the accuracy of subsequent prediction results; in addition, the local space correlation information, free parking space estimation information and time correlation information of the parking lot may be obtained by virtue of different network models, thereby enhancing the accuracy of the obtained result and further enhancing the accuracy of subsequent prediction results; furthermore, when the model is trained, annotation data may be built using historical free parking space information of the parking lots with real-time sensors, and training optimization may be performed, thereby making the annotation data more accurate. A combined objective function may be trained to enhance the model raining effect. Other effects of the above optional manners will be described hereunder in conjunction with specific embodiments.

### BRIEF DESCRIPTION OF DRAWINGS

The figures are intended to facilitate understanding the solutions, not to limit the present disclosure. In the figures,

FIG. 1 illustrates a flow chart of an embodiment of a parking lot free parking space predicting method according to the present disclosure;

FIG. 2 illustrates a schematic diagram of a parking lot association graph according to the present disclosure;

FIG. 3 illustrates a schematic structural diagram of a parking lot free parking space predicting apparatus 300 according to an embodiment of the present disclosure;

FIG. 4 illustrates a block diagram of an electronic device for implementing the method according to embodiments of the present disclosure.

### DETAILED DESCRIPTION OF PREFERRED EMBODIMENTS

Exemplary embodiments of the present disclosure are described below with reference to the accompanying drawings, include various details of the embodiments of the present disclosure to facilitate understanding, and should be considered as merely exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

In addition, it should be appreciated that the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

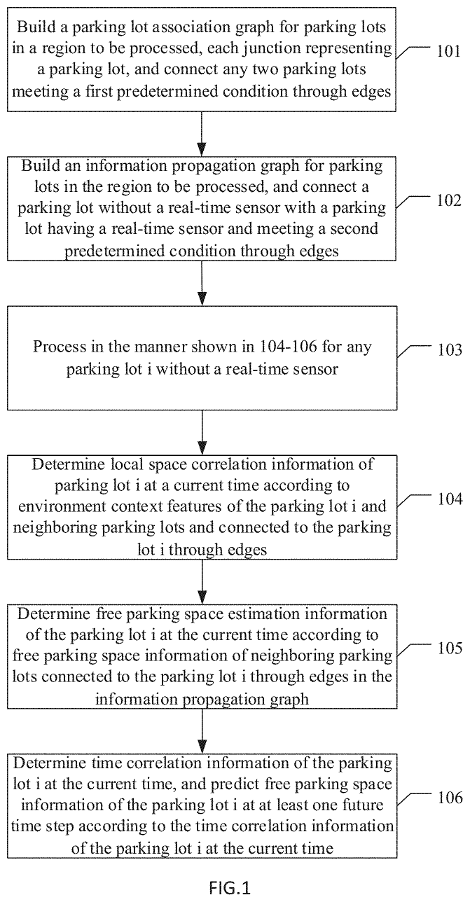

FIG. 1 illustrates a flow chart of an embodiment of a parking lot free parking space predicting method according to the present disclosure. As shown in FIG. 1, the embodiment comprises the following specific implementation mode.

At 101, a parking lot association graph is built for parking lots in a region to be processed, each junction therein represents a parking lot, and any two parking lots meeting a first predetermined condition are connected through edges.

At 102, an information propagation graph is built for parking lots in the region to be processed, each junction therein represents a parking lot, and a parking lot without a real-time sensor is connected with a parking lot having a real-time sensor and meeting a second predetermined condition through edges.

At 103, any parking lot i without a real-time sensor is processed in a manner shown in 104-106.

At 104, local space correlation information of parking lot i at a current time is determined according to environment context features of the parking lot i and neighboring parking lots which are in the parking lot association graph and connected to the parking lot i through edges.

At 105, free parking space estimation information of the parking lot i at the current time is determined according to free parking space information of neighboring parking lots connected to the parking lot i through edges in the information propagation graph.

At 106, time correlation information of the parking lot i at the current time is determined according to the free parking space estimation information and the local space correlation information, and free parking space information of the parking lot i at at least one future time step is predicted according to the time correlation information of the parking lot i at the current time.

Take Beijing as an example. There might be tens of thousands of parking lots in the whole city. However, since real-time sensors are costly, they are mounted in only very few parking lots to monitor in real time the current free parking space information which usually refers to the number of free parking spaces. Hence, it is very necessary to predict free parking space information of parking lots.

Vacancy of parking lots usually has an obvious spatiotemporal attributes. Suppose parking spaces of a parking lot are urgently needed at a time, such an urgent need situation usually lasts for a period of time instead of disappearing immediately. Hence, in the time dimension, if historical free parking space information of the parking lots can be obtained, future free parking space information can be predicted more easily. In the space dimension, the parking lots of the city are usually correlated. For example, a hot scenic spot will usually cause surrounding parking lots to be in a urgently-needed state.

Since free parking space information of parking lots has spatiotemporal correlation and a majority parking lots do not have real-time sensors, in the present embodiment thoughts are given to use free parking space information of few parking lots with real-time sensors to supplement free parking space information of parking lots without real-time sensors in the time dimension and space dimension, to achieve a better prediction effect.

In the present embodiment, to depict the local space correlation, a parking lot association graph may be built for parking lots in a region to be processed (e.g., the city of Beijing), each junction in the parking lot association graph represents a parking lot, and any two parking lots meeting a first predetermined condition are connected through edges. For example, any two parking lots with a distance less than or equal to a predetermined threshold are connected through edges, i.e., parking lots which are close to each other have a strong correlation.

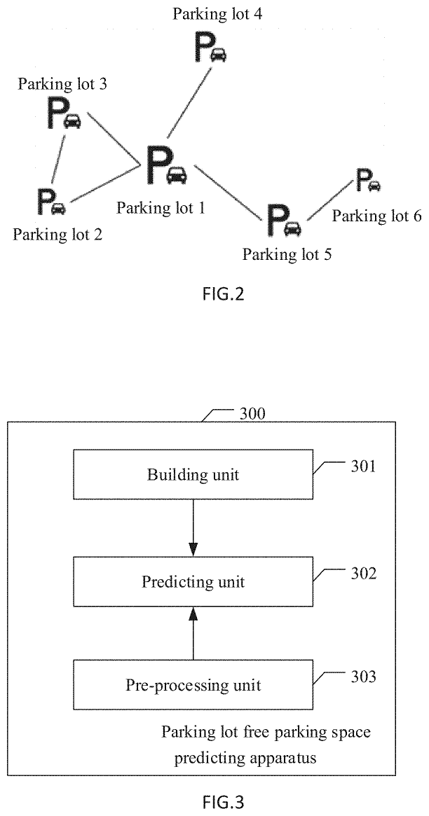

FIG. 2 illustrates a schematic diagram of a parking lot association graph according to the present disclosure. A specific value of the threshold may depend on actual needs, for example, 1 km, and correspondingly, there is the following formula:

$${e}_{ij} = \{ \begin{matrix}1 , & dits ( {v}_{i} , {v}_{j} ) \leq 1 km \\ 0 , & otherwise\end{matrix} ; \qquad ( 1 )$$

That is, if a distance dits(vᵢ, vⱼ) between any two parking lots is less than or equal to 1 km, the two parking lots are connected through edges, otherwise they are not connected. The distance usually refers to a road network distance.

As for any parking lot i without a real-time sensor, local space correlation information of parking lot i at a current time may be determined based on a graph attention neutral network model, according to environment context features of the parking lot i and neighboring parking lots which are in the parking lot association graph and connected to the parking lot i through edges.

The environment context feature of the parking lots may include a peripheral population feature, a peripheral Points of Interest (POIs) distribution feature etc. The specific content included by the environment context features may depend on actual needs. The peripheral refers to a surrounding predetermined scope. The population feature may refer to the number of active users. For example, a user will upload positioning information upon using an app such as a map app, and the user's activity regions may be obtained by using the positioning information. The POI distribution feature may include the number and types of the POIs and so on. In practical application, the obtained environment context features may be represented in the form of vectors according to predetermined rules. The environment context features are dynamically variable.

As shown in FIG. 2, parking lot i is taken as an example. Parking lot 2, parking lot 3, parking lot 4 and parking lot 5 all are neighboring parking lots of parking lot i.

As for the neighboring parking lots of parking lot i in the parking lot association graph, it is feasible to determine weights of edges between the neighboring parking lots and the parking lot i at the current time according to the environment context features of the neighboring parking lots and parking lot i at the current time, respectively, aggregate the environment context features of the neighboring parking lots according to the weights of edges between the neighboring parking lots and the parking lot i to obtain a representation vector of the parking lot i, and regard the representation vector as the local space correlation information of the parking lot i at the current time. Since the environment context features of the parking lots are dynamically variable, the above weights and representation vector are also dynamically variable.

Optionally, as for any neighboring parking lot j, a weight αᵢⱼ between it and the parking lot i may be:

$$\begin{matrix}{α}_{ij} = \frac{exp ( {c}_{ij} )}{{\sum }_{k ∈ {N}_{l}} exp ( {c}_{ik} )} ; & ( 2 ) \\ where {c}_{ij} = Attention ( {W}_{a} {x}_{i} , {W}_{a} {x}_{j} ) ; & ( 3 )\end{matrix}$$

Attention represents a graph attention mechanism; Nᵢ represents the number of neighboring parking lots of the parking lot i in the parking lot association graph; xᵢ represents the environment context feature of the parking lot i at the current time; xⱼ represents the environment context feature of neighboring parking lot j at the current time; Wₐ represents a model parameter obtained by pre-training.

The environment context features of the neighboring parking lots may be aggregated according to the weights of edges between the neighboring parking lots and the parking lot i to obtain the representation vector of the parking lot i. The representation vector xᵢ′ may be:

xᵢ=σ(Σ_{j∈N}_{ᵢ}αᵢⱼWₐxⱼ); (4)

where Nᵢ represents number of neighboring parking lots of the parking lot i in the parking lot association graph; xⱼ represents the environment context feature of any neighboring parking lot j among Nᵢ neighboring parking lots at the current time; αᵢⱼ represents a weight of the edge between the neighboring parking lot j and parking lot i at the current time; Wₐ represents a model parameter obtained by pre-training; σ represents an activation function.

To make full use of the free parking space information, namely, sensor data, of those parking lots with real-time sensors from the perspective of space, an information propagation graph may also be built for the parking lots in the region to be processed, each junction therein represents a parking lot, and parking lots without real-time sensors are connected with the parking lots having the real-time sensors and meeting a second predetermined condition through edges.

Specifically, as for any parking lot i without a real-time sensor, it is feasible to sort the parking lots with real-time sensors respectively in an ascending order of distance from the parking lot i, and determine a first distance between a parking lot ranking at L after the sorting and the parking lot i, L being a positive integer, connect parking lots ranking before L with the parking lot i through edges if the first distance is greater than a predetermined threshold, otherwise connect parking lots of which a distance from the parking lot i is less than or equal to the threshold and which have real-time sensors with the parking lot i through edges.

As for any parking lot i without a real-time sensor, it is desirable that the free parking space information useful for it propagates from the parking lot with a real-time sensor to the parking lot i. Hence, a directed edge may only be connected from a parking lot at a closer distance from the parking lot i and with the real-time sensor to the parking lot i.

Correspondingly, an equation for building the information propagation graph may be represented as:

$${e}_{ij} = \{ \begin{matrix}1 , & dits ( {p}_{i} , {p}_{j} ) \leq max ( 1 km , {dist}_{Lnn} ( {p}_{i} ) ) , i \neq j \\ 0 , & otherwise\end{matrix} ; \qquad ( 5 )$$

where dist_{Lnn}(pᵢ) represents a distance between a parking lot being the L^{th} closest to the parking lot i and having a real-time sensor and the parking lot i, namely, the first distance. As compared with Equation (1), the condition for building the graph in Equation (5) is less stringent so that the free parking space information may propagate more sufficiently, and the sparsity problem of tag data may be eased. A specific value of L may depend on actual needs, and is usually greater than 1.

Aggregation may be performed from the information propagation graph by using an attention neural network model to obtain effective free parking space information needed by the parking lot i, as sensor data for complementing its space. That is, as for the parking lot i, the free parking space estimation information of the parking lot i at the current time may be determined according to the free parking space information of neighboring parking lots connected with the parking lot i through edges in the information propagation graph.

Specifically, as for the neighboring parking lots of the parking lot i in the information propagation graph, it is possible to determine weights of edges between the neighboring parking lots and the parking lot i at the current time according to environment context features of the neighboring parking lots and the parking lot i at the current time, respectively, and determine the free parking space estimation information of the parking lot i in a space dimension at the current time according to the weights of edges between the neighboring parking lots and the parking lot i and the free parking space information of the neighboring parking lots at the current time.

Reference may be made to the preceding relevant depictions to determine the weights of edges between the neighboring parking lots and the parking lot i at the current time.

The free parking space estimation information xᵢ^{sp} of the parking lot i in the space dimension at the current time may be:

xᵢ^{sp}=Σ_{j∈Q}_{ᵢ}α′ᵢⱼyⱼ; (6)

where Qᵢ represents the number of neighboring parking lots of the parking lot i in the information propagation graph: yⱼ represents the free parking space information of any neighboring parking lot j in Qᵢ neighboring parking lots at the current time; α′ᵢⱼ; represents a weight of the edge between the neighboring parking lot j and parking lot i at the current time.

yⱼ may be the free parking space information after predetermined processing, e.g., predetermined normalization and discretization processing, so that it becomes a one-hot vector with a predetermined dimension (e.g., P dimensions, where P is a positive integer greater than one). xᵢ^{sp} obtained in this way will be a predetermined dimension distribution vector regarding the free parking space information, and better saves the free parking space information of the parking lots being related thereto and having real-time sensors.

What is obtained above is the free parking space estimation information of the parking lot i in the space dimension at the current time. As for the parking lot i, it is also feasible to determine the free parking space estimation information of the parking lot i in a time dimension at the current time according to output of a gated recurrent neural network model at a previous time, and fuse the free parking space estimation information in the time dimension with the free parking space estimation information in the space dimension to obtain finally-needed free parking space estimation information of the parking lot i at the current time.

The free parking space estimation information xᵢ^{tp} of the parking lot i in the time dimension at the current time may be:

xᵢ^{tp}=Softmax(Wₜₚhᵢ^{t-1}); (7)

where Wₜₚ is a model parameter obtained by pre-training; hᵢ^{t-1} represents output of the gated recurrent neural network model at the previous time.

The output of the gated recurrent neural network model at the previous time includes rich historical spatiotemporal information of the parking lot i, and may be used to estimate the free parking space information of the parking lot i at the current time. Softmax plays a normalization role and ensures that xᵢ^{tp} is also a predetermined dimension distribution vector.

Preferably, the obtained free parking space estimation information in the time dimension and free parking space estimation information in the space dimension may be fused based on an entropy mechanism.

The fused free parking space estimation information xᵢ^{p} of the parking lot i may be:

$${x}_{i}^{p} = \frac{exp ( - H ( {x}_{i}^{sp} ) ) {x}_{i}^{sp} + exp ( - H ( {x}_{i}^{tp} ) ) {x}_{i}^{tp}}{{Z}_{i}} ; \qquad ( 8 )$$

where Zᵢ=exp(−H(xᵢ^{sp}))+exp(−H(xᵢ^{tp})) and is a normalization factor; xᵢ^{sp} represents the free parking space estimation information of the parking lot i in the space dimension at the current time; xᵢ^{tp} represents the free parking space estimation information of the parking lot i in the time dimension at the current time.

H represents a predetermined function, and

H(xᵢ)=−Σⱼ₌₁^{P}xᵢ(j)log xᵢ(j); (9)

where xᵢ(j) represents the j^{th} dimension of xᵢ.

Furthermore, the free parking space estimation information of the parking lot i at the current time may be concatenated with the local space correlation information. The concatenation may refer to connecting end to end.

As for the parking lot i, time correlation information of the parking lot i at the current time may be determined based on the gated recurrent neural network model, and the free parking space information of the parking lot i at at least one future time step may be predicted according to the time correlation information of the parking lot i at the current time. preferably, it is possible to determine the time correlation information of parking lot i at the current time according to a concatenation result and output of the gated recurrent neural network model at a previous time, and predict the free parking space information of the parking lot i at at least one future time step according to the time correlation information of the parking lot i at the current time.

The time correlation information h of the parking lot i at the current time may be:

hᵢ^{t}=(1−zᵢ^{t})·hᵢ^{t-1}+zᵢ^{t}·\tilde{h}ᵢ^{t}; (10)

where zᵢ^{t}=σ(W_{z}[hᵢ^{t-1},xᵢ″]+b_{z}); (11)

\tilde{h}ᵢ^{t}=tan h(W_{\tilde{h}}[rᵢ^{t}·hᵢ^{t-1},xᵢ″]+b_{\tilde{h}}); (12)

rᵢ^{t}=σ(Wᵣ[hᵢ^{t-1},xᵢ″]+bᵣ); (13)

W_{z}, W_{\tilde{h}}, Wᵣ, b_{z}, b_{\tilde{h}} and bᵣ all are model parameters obtained by pre-training; σ represents an activation function; xᵢ″ represents a concatenation result; hᵢ^{t-1} represents the output of the gated recurrent neural network model at a previous time; · represents a matrix multiplication.

The free parking space information of the parking lot i at at least one future time step may be predicted using hᵢ^{t}, for example, the free parking space information of the parking lot i at future r time steps may be predicted in the following manner:

(ŷᵢ^{t+1}, . . . ,ŷᵢ^{t+τ})=σ(Wₒhᵢ^{t}); (14)

where τ is a positive integer greater than one, and its specific value may depends on actual needs; hᵢ^{t} represents the time correlation information of the parking lot i at the current time; Wₒ represents a model parameter obtained by pre-training, a represents an activation function; ŷᵢ^{t+1} represents the predicted free parking space information of the parking lot at a first future time step; ŷᵢ^{t+τ} represents the predicted free parking space information of the parking lot i at τ^{th} future time step.

Suppose the value of τ is 3, the free parking space information of the parking lot i at the first future time step, the second future time step and the third future time step, respectively according to the Equation (14).

A time step for example may be 15 minutes. In practical application, for example, as for the parking lot i, prediction is performed one time every 15 minutes in the manner stated in the present embodiment, i.e., the free parking space information of the parking lot i at three future time steps may be predicted.

In addition, when the model is trained, Nₗ parking lots with real-time sensors may be selected as sample parking lots, annotation data may be built based on historical free parking space information of the sample parking lots, training optimization may be performed based on the annotation data, and an objective of training optimization is to minimize a combined objective function O.

The combined objective function

$$\begin{matrix}O = {O}_{1} + \frac{1}{2} ( {O}_{2} + {O}_{3} ) ; & ( 15 ) \\ {O}_{1} = \frac{1}{τ {N}_{l}} {\sum }_{i = 1}^{{N}_{l}} {\sum }_{j = 1}^{τ} {( {\hat{y}}_{i}^{t + j} - {y}_{i}^{t + j} )}^{2} ; & ( 16 ) \\ {O}_{2} = - \frac{1}{{N}_{l}} {\sum }_{i = 1}^{{N}_{l}} {y}_{i}^{t} log {x}_{i}^{sp} ; & ( 17 ) \\ {O}_{3} = - \frac{1}{{N}_{l}} {\sum }_{i = 1}^{{N}_{l}} {y}_{i}^{t} log {x}_{i}^{tp} ; & ( 18 )\end{matrix}$$

Nₗ is a positive integer greater than 1, and its specific value may depend on actual needs. yᵢ^{t+j} represents real free parking space information of any sample parking lot i in Nₗ sample parking lots at a corresponding time step; yᵢ^{t} represents real free parking space information of the sample parking lot i at a time t after predetermined processing, wherein the predetermined processing may include predetermined normalization and discretization processing; xᵢ^{sp} represents free parking space estimation information of the sample parking lot i in a space dimension at a time t; xᵢ^{tp} represents free parking space estimation information of the sample parking lot i in a time dimension at a time t. O₂ and O₃ are cross-entropy objective functions and may enhance the model training effect.

The abovementioned model parameters may be learnt through model training. Specific implementation is of the prior art.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

To sum up, according to the solution of the method embodiment of the present application, the local space correlation information and the time correlation information of the parking lot may be determined in conjunction with the environment context features of the parking lot, the free parking space information of the parking lots without real-time sensors may be estimated/complemented by using the free parking space information of the parking lots with real-time sensors, and future free parking space information of the parking lot may be predicted based on these information, thereby improving the accuracy of the prediction result; in addition, the free parking space information of the parking lot may be complemented in a space dimension and a time dimension, thereby enhancing the accuracy of the processing result and further enhancing the accuracy of subsequent prediction results; in addition, the local space correlation information, free parking space estimation information and time correlation information of the parking lot may be obtained by virtue of different network models, thereby enhancing the accuracy of the obtained result and further enhancing the accuracy of subsequent prediction results; furthermore, when the model is trained, annotation data may be built based on historical free parking space information of the parking lots with real-time sensors, and training optimization may be performed, thereby making the annotation data more accurate. A combined objective function may be trained to enhance the model raining effect.

The above introduces the method embodiment. The solution of the present disclosure will be further described through an apparatus embodiment.

FIG. 3 illustrates a schematic structural diagram of a parking lot free parking space predicting apparatus 300 according to an embodiment of the present disclosure. As shown in FIG. 3, the apparatus comprises a building unit 301 and a predicting unit 302.

The building unit 301 is configured to build a parking lot association graph for parking lots in a region to be processed, each junction therein representing a parking lot, and connect any two parking lots meeting a first predetermined condition through edges; build an information propagation graph for parking lots in the region to be processed, each junction therein representing a parking lot, and connect a parking lot without a real-time sensor with a parking lot having a real-time sensor and meeting a second predetermined condition through edges.

The predicting unit 302 is configured to process as follows for any parking lot i without a real-time sensor: determine local space correlation information of parking lot i at a current time according to environment context features of the parking lot i and neighboring parking lots which are in the parking lot association graph and connected to the parking lot i through edges; determine free parking space estimation information of the parking lot i at the current time according to free parking space information of neighboring parking lots connected to the parking lot i through edges in the information propagation graph; determine time correlation information of the parking lot i at the current time according to the free parking space estimation information and the local space correlation information, and predict free parking space information of the parking lot i at at least one future time step according to the time correlation information of the parking lot i at the current time.

As for the parking lot association graph, the building unit 301 may connect any two parking lots with a distance less than or equal to a predetermined threshold through edges.

As for the information propagation graph, the building unit 301 may, as for any parking lot i without a real-time sensor, sort the parking lots with real-time sensors respectively in an ascending order of distance from the parking lot i, and determine a first distance between a parking lot ranking at L after the sorting and the parking lot i, L being a positive integer, connect parking lots ranking before L with the parking lot i through edges if the first distance is greater than a threshold, otherwise connect parking lots of which distance from the parking lot i is less than or equal to the threshold and who have real-time sensors with the parking lot i through edges.

In addition, the predicting unit 302 may determine local space correlation information of parking lot i at a current time based on a graph attention neutral network model, determine time correlation information of the parking lot i at the current time based on a gated recurrent neural network model, and predict the free parking space information of the parking lot i at at least one future time step according to the time correlation information of the parking lot i at the current time.

Specifically, the predicting unit 302 may, as for neighboring parking lots of parking lot i in the parking lot association graph, determine weights of edges between the neighboring parking lots and the parking lot i at the current time according to the environment context features of the neighboring parking lots and parking lot i at the current time, respectively, aggregate the environment context features of the neighboring parking lots according to the weights of edges between the neighboring parking lots and the parking lot i to obtain a representation vector of the parking lot i, and regard the representation vector as the local space correlation information of the parking lot i at the current time.

a weight αᵢⱼ of the edge between any neighboring parking lot j and parking lot i is represented by

$$\begin{matrix}{α}_{ij} = \frac{exp ( {c}_{ij} )}{{\sum }_{k ∈ {N}_{l}} exp ( {c}_{ik} )} ; & ( 2 ) \\ where {c}_{ij} = Attention ( {W}_{a} {x}_{i} , {W}_{a} {x}_{j} ) ; & ( 3 )\end{matrix}$$

Attention represents a graph attention mechanism; Nᵢ represents the number of neighboring parking lots of the parking lot i in the parking lot association graph; xᵢ represents the environment context feature of the parking lot i at the current time; xⱼ represents the environment context feature of neighboring parking lot j at the current time; Wₐ represents a model parameter obtained by pre-training.

the representation vector

xᵢ′=σ(Σ_{j∈N}_{ᵢ}αᵢⱼWₐxⱼ); (4)

where Nᵢ represents number of neighboring parking lots of the parking lot i in the parking lot association graph; xⱼ represents the environment context feature of any neighboring parking lot j among Nᵢ neighboring parking lots at the current time; αᵢⱼ represents a weight of the edge between the neighboring parking lot j and parking lot i at the current time; Wₐ represents a model parameter obtained by pre-training; σ represents an activation function.

The predicting unit 302 may further, as for the neighboring parking lots of the parking lot i in the information propagation graph, determine weights of edges between the neighboring parking lots and the parking lot i at the current time according to environment context features of the neighboring parking lots and the parking lot i at the current time, respectively, and determine free parking space estimation information of the parking lot i in a space dimension at the current time according to the weights of edges between the neighboring parking lots and the parking lot i and the free parking space information of the neighboring parking lots at the current time.

The free parking space estimation information xᵢ^{sp} of the parking lot i in the space dimension at the current time is represented by

xᵢ^{sp}=Σ_{j∈Q}_{ᵢ}α′ᵢⱼyⱼ; (6)

where Qᵢ represents the number of neighboring parking lots of the parking lot i in the information propagation graph; yⱼ represents the free parking space information of any neighboring parking lot j in Qᵢ neighboring parking lots at the current time; α′ᵢⱼ represents a weight of the edge between the neighboring parking lot j and parking lot i at the current time.

The predicting unit 302 may further, as for the parking lot i, determine the free parking space estimation information of the parking lot i in a time dimension at the current time according to output of a gated recurrent neural network model at a previous time, and fuse the free parking space estimation information in the time dimension with the free parking space estimation information in the space dimension to obtain finally-needed free parking space estimation information of the parking lot i at the current time.

The free parking space estimation information xᵢ^{tp} of the parking lot i in the time dimension at the current time is represented by

xᵢ^{tp}=Softmax(Wₜₚhᵢ^{t-1}); (7)

where Wₜₚ is a model parameter obtained by pre-training; hᵢ^{t-1} represents output of the gated recurrent neural network model at a previous time.

The fused free parking space estimation information xᵢ^{p} of the parking lot i is represented by

$${x}_{i}^{p} = \frac{exp ( - H ( {x}_{i}^{sp} ) ) {x}_{i}^{sp} + exp ( - H ( {x}_{i}^{tp} ) ) {x}_{i}^{tp}}{{Z}_{i}} ; \qquad ( 8 )$$

where Zᵢ=exp(−H(xᵢ^{sp}))+exp(−H(xᵢ^{tp})) and is a normalization factor; xᵢ^{sp} represents the free parking space estimation information of the parking lot i in the space dimension at the current time; xᵢ^{tp} represents the free parking space estimation information of the parking lot i in the time dimension at the current time; H represents a predetermined function.

The predicting unit 302 may concatenate the free parking space estimation information of the parking lot i at the current time with the local space correlation information, and determine the time correlation information of parking lot i at the current time according to a concatenation result and output of the gated recurrent neural network model at a previous time.

The time correlation information hᵢ^{t} of the parking lot i at the current time is represented by

hᵢ^{t}=(1−zᵢ^{t})·hᵢ^{t-1}+zᵢ^{t}·\tilde{h}ᵢ^{t}; (10)

where zᵢ^{t}=σ(W_{z}[hᵢ^{t-1},xᵢ″]+b_{z}); (11)

\tilde{h}ᵢ^{t}=tan h(W_{\tilde{h}}[rᵢ^{t}·hᵢ^{t-1},xᵢ″]+b_{\tilde{h}}); (12)

rᵢ^{t}=σ(Wᵣ[hᵢ^{t-1},xᵢ″]+bᵣ); (13)

W_{z}, W_{\tilde{h}}, Wᵣ, b_{z}, b_{\tilde{h}} and bᵣ all are model parameters obtained by pre-training; σ represents an activation function; xᵢ″ represents a concatenation result; hᵢ^{t-1} represents the output of the gated recurrent neural network model at a previous time.

The predicting unit 302 may predict the free parking space information of the parking lot i at future τ time steps in the following manner:

(ŷᵢ^{t+1}, . . . ,ŷᵢ^{t+τ})=σ(Wₒhᵢ^{t}); (14)

where τ is a positive integer greater than one; hᵢ^{t} represents the time correlation information of the parking lot i at the current time; Wₒ represents a model parameter obtained by pre-training, σ represents an activation function; ŷᵢ^{t+1} represents the predicted free parking space information of the parking lot i at a first future time step; ŷᵢ^{t+τ} represents the predicted free parking space information of the parking lot i at τ^{th} future time step.

The apparatus shown in FIG. 3 may further comprise: a pre-processing unit 303 configured to perform model training, where Nₗ parking lots with real-time sensors may be selected as sample parking lots, annotation data may be built based on historical free parking space information of the sample parking lots, training optimization may be performed based on the annotation data, and a combined objective function O may be minimized;

where the combined objective function

$$\begin{matrix}O = {O}_{1} + \frac{1}{2} ( {O}_{2} + {O}_{3} ) ; & ( 15 ) \\ {O}_{1} = \frac{1}{τ {N}_{l}} {\sum }_{i = 1}^{{N}_{l}} {\sum }_{j = 1}^{τ} {( {\hat{y}}_{i}^{t + j} - {y}_{i}^{t + j} )}^{2} ; & ( 16 ) \\ {O}_{2} = - \frac{1}{{N}_{l}} {\sum }_{i = 1}^{{N}_{l}} {y}_{i}^{t} log {x}_{i}^{sp} ; & ( 17 ) \\ {O}_{3} = - \frac{1}{{N}_{l}} {\sum }_{i = 1}^{{N}_{l}} {y}_{i}^{t} log {x}_{i}^{tp} ; & ( 18 )\end{matrix}$$

where Nₗ is a positive integer greater than 1; yᵢ^{t+j} represents real free parking space information of any sample parking lot i at a corresponding time step; yᵢ^{t} represents real free parking space information of the sample parking lot i at a time t after predetermined processing; xᵢ^{sp} represents free parking space estimation information of the sample parking lot i in a space dimension at a time t; xᵢ^{tp} represents free parking space estimation information of the sample parking lot i in a time dimension at a time t.

A specific workflow of the apparatus embodiment shown in FIG. 3 will not be detailed any more here, and reference may be made to corresponding depictions in the above method embodiment.

To sum up, according to the solution of the apparatus embodiment of the present application, the local space correlation information and the time correlation information of the parking lot may be determined in conjunction with the environment context features of the parking lot, the free parking space information of the parking lots without real-time sensors may be estimated/complemented by using the free parking space information of the parking lots with real-time sensors, and future free parking space information of the parking lot may be predicted based on these information, thereby improving the accuracy of the prediction result; in addition, the free parking space information of the parking lot may be complemented in a space dimension and a time dimension, thereby enhancing the accuracy of the processing result and further enhancing the accuracy of subsequent prediction results; in addition, the local space correlation information, free parking space estimation information and time correlation information of the parking lot may be obtained by virtue of different network models, thereby enhancing the accuracy of the obtained result and further enhancing the accuracy of subsequent prediction results; furthermore, when the model is trained, annotation data may be built based on historical free parking space information of the parking lots with real-time sensors, and training optimization may be performed, thereby making the annotation data more accurate. A combined objective function may be trained to enhance the model raining effect.

According to embodiments of the present disclosure, the present disclosure further provides an electronic device and a readable storage medium.

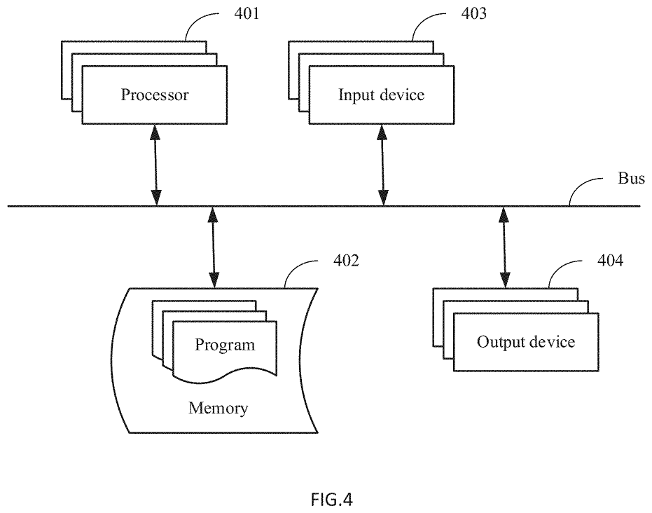

As shown in FIG. 4, it shows a block diagram of an electronic device for the method according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 4, the electronic device comprises: one or more processors 401, a memory 402, and interfaces connected to components and including a high-speed interface and a low speed interface. Each of the components are interconnected using various busses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 401 is taken as an example in FIG. 4.

The memory 402 is a non-transitory computer-readable storage medium provided by the present disclosure. Wherein, the memory stores instructions executable by at least one processor, so that the at least one processor executes the method provided by the present disclosure. The non-transitory computer-readable storage medium of the present disclosure stores computer instructions, which are used to cause a computer to execute the method according to the present disclosure.

The memory 402 is a non-transitory computer-readable storage medium and can be used to store non-transitory software programs, non-transitory computer executable programs and modules, such as program instructions/modules corresponding to the method in embodiments of the present disclosure. The processor 401 executes various functional applications and data processing of the server, i.e., implements the method in the above method embodiment, by running the non-transitory software programs, instructions and units stored in the memory 402.

The memory 402 may include a storage program region and a storage data region, wherein the storage program region may store an operating system and an application program needed by at least one function; the storage data region may store data created according to the use of the electronic device for implementing the video blending method according to the embodiment of the present disclosure. In addition, the memory 402 may include a high-speed random access memory, and may also include a non-transitory memory, such as at least one magnetic disk storage device, a flash memory device, or other non-transitory solid-state storage device. In some embodiments, the memory 402 may optionally include a memory remotely arranged relative to the processor 401, and these remote memories may be connected to the electronic device for implementing the video blending method according to embodiments of the present disclosure through a network. Examples of the above network include, but are not limited to, the Internet, an intranet, a local area network, a mobile communication network, and combinations thereof.

The electronic device for implementing the video blending method may further include an input device 403 and an output device 404. The processor 401, the memory 402, the input device 403 and the output device 404 may be connected through a bus or in other manners. In FIG. 4, the connection through the bus is taken as an example.

The input device 403 may receive inputted numeric or character information and generate key signal inputs related to user settings and function control of the electronic device for implementing the video blending method according to the embodiment of the present disclosure, and may be an input device such as a touch screen, keypad, mouse, trackpad, touchpad, pointing stick, one or more mouse buttons, trackball and joystick. The output device 404 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A parking lot free parking space predicting method, wherein the method comprises:
building a parking lot association graph for parking lots in a region to be processed, each junction therein representing a parking lot, and connecting any two parking lots meeting a first predetermined condition through edges;
building an information propagation graph for parking lots in the region to be processed, each junction therein representing a parking lot, and connecting a parking lot without a real-time sensor with a parking lot having a real-time sensor and meeting a second predetermined condition through edges;
processing as follows for any parking lot i without a real-time sensor:
determining local space correlation information of parking lot i at a current time according to environment context features of the parking lot i and neighboring parking lots which are in the parking lot association graph and connected to the parking lot i through edges;
determining free parking space estimation information of the parking lot i at the current time according to free parking space information of neighboring parking lots connected to the parking lot i through edges in the information propagation graph;
determining time correlation information of the parking lot i at the current time according to the free parking space estimation information and the local space correlation information, and predicting free parking space information of the parking lot i at at least one future time step according to the time correlation information of the parking lot i at the current time.

2. The method according to claim 1, wherein
the connecting any two parking lots meeting a predetermined condition through edges comprises: connecting any two parking lots with a distance less than or equal to a predetermined threshold through edges;
the connecting a parking lot without a real-time sensor with a parking lot having a real-time sensor and meeting a second predetermined condition through edges comprises: as for any parking lot i without a real-time sensor, sorting the parking lots with real-time sensors respectively in an ascending order of distance from the parking lot i, and determining a first distance between a parking lot ranking at L after the sorting and the parking lot i, L being a positive integer, connecting parking lots ranking before L with the parking lot i through edges if the first distance is greater than a threshold, otherwise connecting parking lots of which a distance from the parking lot i is less than or equal to the threshold and which have real-time sensors with the parking lot i through edges.

3. The method according to claim 2, wherein
the determining local space correlation information of parking lot i at a current time comprises: determining local space correlation information of parking lot i at a current time based on a graph attention neutral network model;
the determining time correlation information of the parking lot i at the current time, and the predicting free parking space information of the parking lot i at at least one future time step according to the time correlation information of the parking lot i at the current time comprises: determining time correlation information of the parking lot i at the current time based on a gated recurrent neural network model, and predicting the free parking space information of the parking lot i at at least one future time step according to the time correlation information of the parking lot i at the current time.

4. The method according to claim 3, wherein
the determining local space correlation information of parking lot i at a current time based on a graph attention neutral network model comprises:
as for neighboring parking lots of parking lot i in the parking lot association graph, determining weights of edges between the neighboring parking lots and the parking lot i at the current time according to the environment context features of the neighboring parking lots and parking lot i at the current time, respectively;
aggregating the environment context features of the neighboring parking lots according to the weights of edges between the neighboring parking lots and the parking lot i to obtain a representation vector of the parking lot i, and regarding the representation vector as the local space correlation information of the parking lot i at the current time.

5. The method according to claim 4, wherein
a weight αᵢⱼ of the edge between any neighboring parking lot j and parking lot i is represented by
$${α}_{ij} = \frac{exp ( {c}_{ij} )}{{\sum }_{k ∈ {N}_{i}} exp ( {c}_{ik} )} ;$$
where cᵢⱼ=Attention(Wₐxᵢ,Wₐxⱼ); Attention represents a graph attention mechanism; Nᵢ represents the number of neighboring parking lots of the parking lot i in the parking lot association graph; xᵢ represents the environment context feature of the parking lot i at the current time; xⱼ represents the environment context feature of neighboring parking lot j at the current time; Wₐ represents a model parameter obtained by pre-training.

6. The method according to claim 4, wherein
the representation vector xᵢ′=σ(Σ_{j∈N}_{ᵢ}αᵢⱼWₐxⱼ);
where Nᵢ represents number of neighboring parking lots of the parking lot i in the parking lot association graph; xⱼ represents the environment context feature of any neighboring parking lot j among Nᵢ neighboring parking lots at the current time; αᵢⱼ represents a weight of the edge between the neighboring parking lot j and parking lot i at the current time; Wₐ represents a model parameter obtained by pre-training; σ represents an activation function.

7. The method according to claim 3, wherein
the determining free parking space estimation information of the parking lot i at the current time comprises:
as for the neighboring parking lots of the parking lot i in the information propagation graph, determining weights of edges between the neighboring parking lots and the parking lot i at the current time according to environment context features of the neighboring parking lots and the parking lot i at the current time, respectively;
determining free parking space estimation information of the parking lot i in a space dimension at the current time according to the weights of edges between the neighboring parking lots and the parking lot i and the free parking space information of the neighboring parking lots at the current time.

8. The method according to claim 7, wherein
the free parking space estimation information xᵢ^{sp} of the parking lot i in the space dimension at the current time is represented by xᵢ^{sp}=Σ_{j∈Q}_{ᵢ}α′ᵢⱼyⱼ;
where Qᵢ represents the number of neighboring parking lots of the parking lot i in the information propagation graph; yⱼ represents the free parking space information of any neighboring parking lot j in Qᵢ neighboring parking lots at the current time; α′ᵢⱼ represents a weight of the edge between the neighboring parking lot j and parking lot i at the current time.

9. The method according to claim 7, wherein
the method further comprises:
as for the parking lot i, determining free parking space estimation information of the parking lot i in a time dimension at the current time according to output of the gated recurrent neural network model at a previous time;
fusing the free parking space estimation information in the time dimension with the free parking space estimation information in the space dimension to obtain finally-needed free parking space estimation information of the parking lot i at the current time.

10. The method according to claim 9, wherein
the free parking space estimation information xᵢ^{tp} of the parking lot i in the time dimension at the current time is represented by xᵢ^{tp}=Softmax(Wₜₚhᵢ^{t-1});
where Wₜₚ is a model parameter obtained by pre-training; hᵢ^{t-1} represents output of the gated recurrent neural network model at the previous time.

11. The method according to claim 9, wherein
the fused free parking space estimation information xᵢ^{p} of the parking lot i is represented by
$${x}_{i}^{p} = \frac{exp ( - H ( {x}_{i}^{sp} ) ) {x}_{i}^{sp} + exp ( - H ( {x}_{i}^{tp} ) ) {x}_{i}^{tp}}{{Z}_{i}} ;$$
where Zᵢ=exp(−H(xᵢ^{sp}))+exp(−H(xᵢ^{tp})) and is a normalization factor; xᵢ^{sp} represents the free parking space estimation information of the parking lot i in the space dimension at the current time; xᵢ^{tp} represents the free parking space estimation information of the parking lot i in the time dimension at the current time; H represents a predetermined function.

12. The method according to claim 3, wherein
before determining time correlation information of the parking lot i at the current time based on a gated recurrent neural network model, the method further comprises: concatenating the free parking space estimation information of the parking lot i at the current time with the local space correlation information; and
the determining time correlation information of the parking lot i at the current time based on a gated recurrent neural network model comprises: determining the time correlation information of parking lot i at the current time according to a concatenation result and output of the gated recurrent neural network model at a previous time.

13. The method according to claim 12, wherein
the time correlation information hᵢ^{t} of the parking lot i at the current time is represented by
hᵢ^{t}=(1−zᵢ^{t})·hᵢ^{t-1}+zᵢ^{t}·\tilde{h}ᵢ^{t};
where zᵢ^{t}=σ(W_{z}[hᵢ^{t-1},xᵢ″]+b_{z});
\tilde{h}ᵢ^{t}=tan h(W_{\tilde{h}}[rᵢ^{t}·hᵢ^{t-1},xᵢ″]+b_{\tilde{h}});
rᵢ^{t}=σ(Wᵣ[hᵢ^{t-1},xᵢ″]+bᵣ);
W_{z}, W_{\tilde{h}}, Wᵣ, b_{z}, b_{\tilde{h}} and bᵣ all are model parameters obtained by pre-training; σ represents an activation function; xᵢ″ represents the concatenation result; hᵢ^{t-1} represents the output of the gated recurrent neural network model at the previous time.

14. The method according to claim 3, wherein
the predicting free parking space information of the parking lot i at at least one future time step according to the time correlation information of the parking lot i at the current time comprises:
predicting the free parking space information of the parking lot i at future r time steps in the following manner: (ŷᵢ^{t+1}, . . . , ŷᵢ^{t+τ})=σ(Wₒhᵢ^{t});
where τ is a positive integer greater than one; hᵢ^{t} represents the time correlation information of the parking lot i at the current time; Wₒ represents a model parameter obtained by pre-training, σ represents an activation function; ŷᵢ^{t+1} represents the predicted free parking space information of the parking lot i at a first future time step; ŷᵢ^{t+τ} represents the predicted free parking space information of the parking lot i at τ^{th} future time step.

15. The method according to claim 14, wherein
the method further comprises:
when performing model training, selecting Nₗ parking lots with real-time sensors as sample parking lots, building annotation data based on historical free parking space information of the sample parking lots, performing training optimization based on the annotation data, and minimizing a combined objective function O;
$$where O = {O}_{1} + \frac{1}{2} ( {O}_{2} + {O}_{3} ) ;$$
$${O}_{1} = \frac{1}{τ {N}_{l}} {\sum }_{i = 1}^{{N}_{l}} {\sum }_{j = 1}^{τ} {( {\hat{y}}_{i}^{t + j} - {y}_{i}^{t + j} )}^{2} ;$$
$${O}_{2} = - \frac{1}{{N}_{l}} {\sum }_{i = 1}^{{N}_{l}} {y}_{i}^{t} log {x}_{i}^{sp} ;$$
$${O}_{3} = - \frac{1}{{N}_{l}} {\sum }_{i = 1}^{{N}_{l}} {y}_{i}^{t} log {x}_{i}^{tp} ;$$
where Nₗ is a positive integer greater than 1; yᵢ^{t+j} represents real free parking space information of any sample parking lot i at a corresponding time step; yᵢ^{t} represents real free parking space information of the sample parking lot i at a time t after predetermined processing; xᵢ^{sp} represents free parking space estimation information of the sample parking lot i in a space dimension at a time t; xᵢ^{tp} represents free parking space estimation information of the sample parking lot i in a time dimension at a time t.

16. An electronic device, comprising
at least one processor; and
a memory communicatively connected with the at least one processor;
wherein the memory stores instructions executable by the at least one processor, and the instructions are executed by the at least one processor to enable the at least one processor to perform a parking lot free parking space predicting method, wherein the method comprises:
building a parking lot association graph for parking lots in a region to be processed, each junction therein representing a parking lot, and connecting any two parking lots meeting a first predetermined condition through edges;
building an information propagation graph for parking lots in the region to be processed, each junction therein representing a parking lot, and connecting a parking lot without a real-time sensor with a parking lot having a real-time sensor and meeting a second predetermined condition through edges;
processing as follows for any parking lot i without a real-time sensor:
determining local space correlation information of parking lot i at a current time according to environment context features of the parking lot i and neighboring parking lots which are in the parking lot association graph and connected to the parking lot i through edges;
determining free parking space estimation information of the parking lot i at the current time according to free parking space information of neighboring parking lots connected to the parking lot i through edges in the information propagation graph;
determining time correlation information of the parking lot i at the current time according to the free parking space estimation information and the local space correlation information, and predicting free parking space information of the parking lot i at at least one future time step according to the time correlation information of the parking lot i at the current time.

17. The electronic device according to claim 16, wherein
the connecting any two parking lots meeting a predetermined condition through edges comprises: connecting any two parking lots with a distance less than or equal to a predetermined threshold through edges;
the connecting a parking lot without a real-time sensor with a parking lot having a real-time sensor and meeting a second predetermined condition through edges comprises: as for any parking lot i without a real-time sensor, sorting the parking lots with real-time sensors respectively in an ascending order of distance from the parking lot i, and determining a first distance between a parking lot ranking at L after the sorting and the parking lot i, L being a positive integer, connecting parking lots ranking before L with the parking lot i through edges if the first distance is greater than a threshold, otherwise connecting parking lots of which a distance from the parking lot i is less than or equal to the threshold and which have real-time sensors with the parking lot i through edges.

18. The electronic device according to claim 17, wherein
the determining local space correlation information of parking lot i at a current time comprises: determining local space correlation information of parking lot i at a current time based on a graph attention neutral network model;
the determining time correlation information of the parking lot i at the current time, and the predicting free parking space information of the parking lot i at at least one future time step according to the time correlation information of the parking lot i at the current time comprises: determining time correlation information of the parking lot i at the current time based on a gated recurrent neural network model, and predicting the free parking space information of the parking lot i at at least one future time step according to the time correlation information of the parking lot i at the current time.

19. The electronic device according to claim 18, wherein
the determining local space correlation information of parking lot i at a current time based on a graph attention neutral network model comprises:
as for neighboring parking lots of parking lot i in the parking lot association graph, determining weights of edges between the neighboring parking lots and the parking lot i at the current time according to the environment context features of the neighboring parking lots and parking lot i at the current time, respectively;
aggregating the environment context features of the neighboring parking lots according to the weights of edges between the neighboring parking lots and the parking lot i to obtain a representation vector of the parking lot i, and regarding the representation vector as the local space correlation information of the parking lot i at the current time.

20. A non-transitory computer-readable storage medium storing computer instructions therein, wherein the computer instructions are used to cause the computer to perform a parking lot free parking space predicting method, wherein the method comprises:
building a parking lot association graph for parking lots in a region to be processed, each junction therein representing a parking lot, and connecting any two parking lots meeting a first predetermined condition through edges,
building an information propagation graph for parking lots in the region to be processed, each junction therein representing a parking lot, and connecting a parking lot without a real-time sensor with a parking lot having a real-time sensor and meeting a second predetermined condition through edges;
processing as follows for any parking lot i without a real-time sensor:
determining local space correlation information of parking lot i at a current time according to environment context features of the parking lot i and neighboring parking lots which are in the parking lot association graph and connected to the parking lot i through edges;
determining free parking space estimation information of the parking lot i at the current time according to free parking space information of neighboring parking lots connected to the parking lot i through edges in the information propagation graph;
determining time correlation information of the parking lot i at the current time according to the free parking space estimation information and the local space correlation information, and predicting free parking space information of the parking lot i at at least one future time step according to the time correlation information of the parking lot i at the current time.
